(19) United States
(12) Patent Application Publication
(10) Pub. No.: US 2014/0186733 A1
(43) Pub. Date: Jul. 3, 2014

(54) FUEL CELL SYSTEM WITH ANODE RECYCLING

(71) Applicant: Saint-Gobain Ceramics & Plastics, Inc., Worcester, MA (US)

(72) Inventor: Chunming Qi, Hopkinton, MA (US)

(73) Assignee: Saint-Gobain Ceramics & Plastics, Inc., Worcester, MA (US)

(21) Appl. No.: 14/132,981

(22) Filed: Dec. 18, 2013

Related U.S. Application Data
(60) Provisional application No. 61/747,466, filed on Dec. 31, 2012.

(51) Int. Cl. H01M 8/04

(52) U.S. Cl. CPC H01M 8/04014; H01M 8/04708
USPC 429/431

(57) ABSTRACT

A fuel cell system including: a fuel cell assembly; a fuel feed conduit; a gas feed conduit; an anode exhaust. The anode exhaust conduit is in fluid communication with the fuel feed conduit and at least a portion of a fluid in the anode exhaust conduit is recycled to the fuel feed conduit. The fuel cell system may include a temperature measurement device for determining a fuel cell temperature and/or a current measurement device for determining a fuel cell current. A first control can be configured to control a flow rate of the fluid in the anode exhaust conduit which is recycled into the fuel feed conduit in response to the fuel cell temperature. A second control can be configured to control a flow rate of a fluid in the gas feed conduit in response to the fuel cell current.

### CROSS-REFERENCE TO RELATED APPLICATION(S)

The present application claims priority from U.S. Provisional Application No. 61/747,466, filed Dec. 31, 2012, entitled “Fuel Cell System with Anode Recycling,” naming inventor Chunming Qi, which application is incorporated by reference herein its entirety.

### BACKGROUND

Fuel cells can offer potentially clean, quiet and efficient power generation Unlike thermal energy based engines, fuel cells use an electrochemical or battery-like process to convert the chemical energy associated with the conversion of hydrogen gas (and carbon monoxide for high temperature fuel cells) into water (and carbon dioxide for high temperature fuel cells) into electricity. Among various types of fuel cells, solid oxide fuel cells (SOFC) use hard ceramic compounds of metal oxides (e.g., calcium or zirconium oxides) to form their components, for example, electrodes, electrolytes and interconnects. Typically, in solid oxide fuel cells, oxygen gas (O₂) is reduced to oxygen ions (O⁻²) at the cathode, and a fuel gas, such as hydrogen (H2) or a hydrocarbon, such as methane (CH₄), is oxidized with the oxygen ions to form water and carbon dioxide (from hydrocarbon) at the anode. If a hydrocarbon is used as the fuel gas, then carbon dioxide (CO₂) is also produced and becomes part of the exhaust from the anode of SOFC (anode exhaust). The anode exhaust typically includes about 15% to about 30% unreacted fuel gas. Despite the advantages of clean and quiet power generation, fuel cell systems have faced a number of formidable market entry issues resulting from product immaturity, over-engineered system complexity, fuel efficiency, etc. Fuel efficiency can be increased by employing larger surface areas of the anode and cathode, or by increasing the number of fuel cells in a fuel cell stack. However, these approaches typically result in increases in the size of the fuel cell stack. It is a considerable challenge for an SOFC stack to achieve high fuel utilization efficiency due to the limitation of cell voltage and uniform fuel distribution.

Therefore, there is a need for developing methods of increasing fuel efficiency in fuel cell systems, and for developing fuel cell systems having high fuel efficiency, and in particular fuel cell systems of relatively small size.

### BRIEF DESCRIPTION OF THE DISCLOSURE

A first aspect of the present disclosure includes a fuel cell system comprising: a fuel cell assembly comprising an anode and a cathode; a fuel feed conduit in fluid communication with the fuel cell assembly; a gas feed conduit in fluid communication with the fuel cell assembly, an anode exhaust conduit in fluid communication with the fuel cell assembly, wherein the anode exhaust conduit is in fluid communication with the fuel feed conduit and wherein at least a portion of a fluid in the anode exhaust conduit is recycled to the fuel feed conduit; a temperature measurement device for determining a fuel cell temperature; a current measurement device for determining a fuel cell current; a first control in communication with the temperature measurement device, wherein the first control is configured to control a flow rate of the fluid in the anode exhaust conduit which is recycled into the fuel feed conduit in response to the fuel cell temperature; and a second control in communication with the current measurement device, wherein the second control is configured to control a flow rate of a fluid in the gas feed conduit in response to the fuel cell current.

Another aspect of the present disclosure includes a fuel cell system comprising: a fuel cell assembly comprising an anode and a cathode; a fuel feed conduit in fluid communication with the fuel cell assembly; a gas feed conduit in fluid communication with the fuel cell assembly, an anode exhaust conduit in fluid communication with the fuel cell assembly; wherein the anode exhaust conduit is in fluid communication with the fuel feed conduit and wherein at least a portion of a fluid in the anode exhaust conduit is recycled to the fuel feed conduit; a cathode exhaust conduit in fluid communication with the fuel cell assembly; a temperature measurement device for determining a fuel cell temperature; an oxygen content measurement device for determining an oxygen content of fluid in the cathode exhaust conduit; a first control in communication with the temperature measurement device, wherein the first control is configured to control a flow rate of the fluid in the anode exhaust conduit which is recycled into the fuel feed conduit in response to the fuel cell temperature; and a second control in communication with the oxygen content measurement device, wherein the second control is configured to control a flow rate of a fluid in the gas feed conduit in response to the oxygen content of the fluid in the cathode exhaust conduit.

Another aspect of the present disclosure includes a method of operating a fuel cell system comprising: directing a first fluid into an anode of a fuel cell assembly; directing a second fluid into a cathode of the fuel cell assembly; sensing a temperature in the fuel cell; determining a current of the fuel cell; combining at least a portion of a third fluid exiting the anode of a fuel cell assembly with the first fluid, wherein the flow rate of the third fluid which is combined with the first fluid is directly influenced by the temperature sensed in the fuel cell; and controlling a flow rate of the second fluid in response to the determined current of the fuel cell.

Yet another aspect of the present disclosure includes a method of operating a fuel cell system comprising: directing a first fluid into an anode of a fuel cell assembly; directing a second fluid into a cathode of the fuel cell assembly; sensing a temperature in the fuel cell; determining an oxygen utilization of the fuel cell assembly; combining at least a portion of a third fluid exiting the anode of a fuel cell assembly with the first fluid, wherein the flow rate of the third fluid which is combined with the first fluid is directly influenced by the temperature sensed in the fuel cell; and controlling a flow rate of the second fluid in response to the determined oxygen utilization of the fuel cell assembly.

### BRIEF DESCRIPTION OF THE DRAWINGS

The present disclosure may be better understood, and its numerous features and advantages made apparent to those skilled in the art by referencing the accompanying drawings.

FIG. 1 illustrates a schematic drawing of an embodiment of a fuel cell system.

FIG. 2 illustrates a schematic drawing of an embodiment of a fuel cell system.

FIG. 3 illustrates a plot diagram of the power density versus fuel utilization of a fuel cell system at different voltages according to an embodiment.

Skilled artisans appreciate that elements in the figures are illustrated for simplicity and clarity and have not necessarily been drawn to scale. For example, the dimensions of some of the elements in the figures can be exaggerated relative to other elements to help improve understanding of embodiments of the invention. The use of the same reference symbols in different drawings indicates similar or identical items.

### DETAILED DESCRIPTION OF THE DISCLOSURE

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings.

As used herein, the terms “comprises,” “comprising,” “includes, ” “including, ” “has, ” “having,” or any other variation thereof, are intended to cover a non-exclusive inclusion. For example, a process, method, article, or apparatus that comprises a list of features is not necessarily limited only to those features but can include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

The use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise.

The following disclosure is generally directed to fuel cell systems, in particular fuel cell systems which recycle at least a portion of the anode exhaust into the fuel feed. In embodiments described herein, characteristics of the fuel cell system such as fuel efficiency, thermal integration, and flow control can be improved.

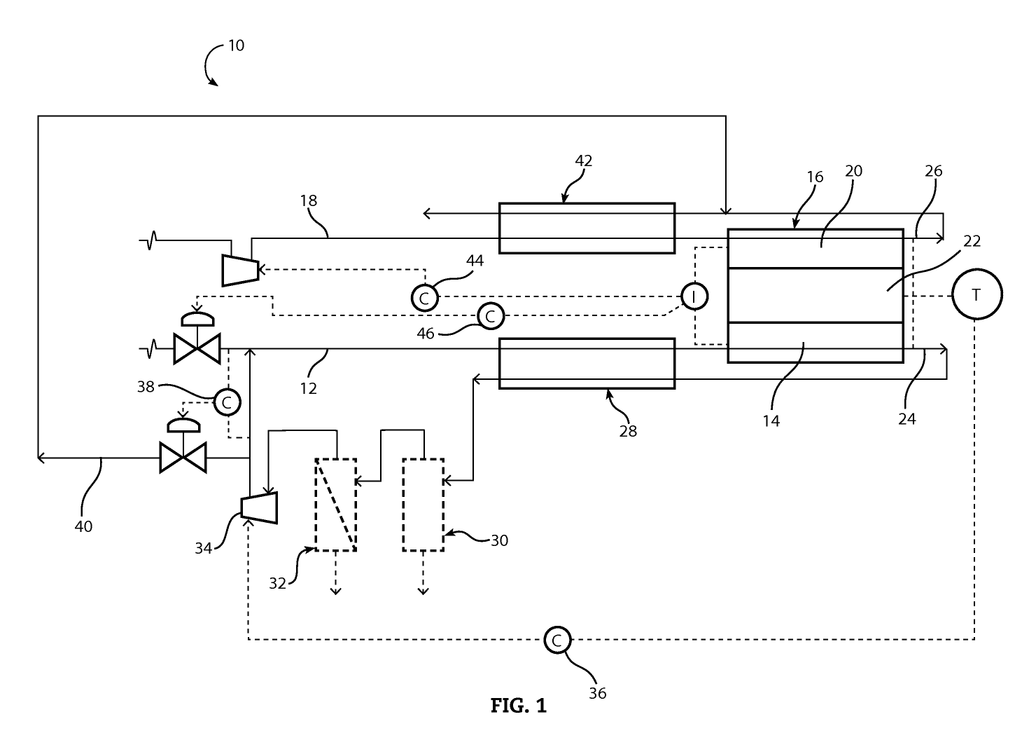

FIG. 1 shows certain embodiments of a fuel cell system 10 described herein. The fuel cell system 10 generally includes: a fuel feed conduit 12 in fluid communication with a fuel source (not shown) and an anode 14 of a fuel cell assembly 16; a gas feed conduit 18 in fluid communication with a gas source (not shown) and a cathode 20 of the fuel cell assembly 16. The fuel cell assembly 16 general includes an anode 14, a cathode 20, and an electrolyte 22 between the anode 14 and cathode 20. When a plurality of fuel cells are employed, fuel cells can be connected to each other via an interconnect (not shown). Any number or types fuel cell assemblies 16 may be employed in the fuel cell system 10 described herein.

In certain embodiments, the fluid in the fuel feed conduit 12 can contain, for example, natural gas, LPG, biogas, biofuel, syngas, coal gas, city gas, methane, propane, gasoline, diesel, H₂, or combinations thereof. In certain embodiments such as including catalytic partial oxidation (CPOX), another fluid (not shown) containing oxygen, in particular embodiments, air can be mixed with the fluid in the gas feed conduit 12 before entering the fuel feed conduit 12 enters the fuel cell assembly 16.

The fuel cell system 10 can further include an anode exhaust conduit 24 in fluid communication with the anode 14 of the fuel cell assembly 16; and a cathode exhaust conduit 26 in fluid communication with the cathode 20 of the fuel cell assembly 16. As illustrated in FIG. 1, the anode exhaust conduit 24 can be in fluid communication with the fuel feed conduit 12 to recycle at least unreacted fuel that passes through the fuel cell assembly 16.

Referring again to FIG. 1, the fuel cell system 10 can further include a first heat exchanger 28 configured to exchange heat between fluid in the anode exhaust conduit 24 and a another fluid. The other fluid can have a lower temperature than the fluid in the anode exhaust conduit 24. In a particular embodiment the other fluid can be the fluid in the fuel feed conduit 12. This arrangement can provide additional thermal energy to reform the fluid in the fuel feed conduit 12, thus providing enhanced energy integration within the fuel cell system 10. In certain embodiments, the first heat exchanger 28 can include a pre-reformer or reformer.

In certain embodiments, the temperature difference between the fluid in the anode exhaust conduit 24 entering the first heat exchanger 28 and the fluid exiting the first heat exchanger 28 can be no greater than about 300° C., no greater than about 200° C., or even no greater than about 100° C.

In certain embodiments, the anode exhaust conduit 24 can be in fluid communication with one or more separation devices 30, 32. For example, as illustrated in FIG. 1, the anode exhaust conduit 24 can be in fluid communication with a first separation device 30 and a second separation device 32.

In certain embodiments, the first separation device 30 can include a device configured to remove water. For example, the first separation device can include, a membrane separation device, a condenser, an adsorption device, an absorption device, and combinations thereof. In particular embodiments, the first separation device 30 includes a condenser. The condenser can be configured to separate water from the fluid in the anode exhaust conduit 24. In certain embodiments, the condenser can be configured to remove at least about 50%, at least about 60%, at least about 70%, or even at least about 80% of the water from the fluid in the anode exhaust conduit 24. In certain further embodiments, the condenser can be configured to remove water from the fluid in the anode exhaust conduit 24 in a range within any of the values given above, for example, in a range of from 50% to 80%.

In certain further embodiments, the second separation device 32 includes a device configured to remove CO₂. In certain embodiments, the second separation device 32 can include a membrane separation device, a condenser, an adsorption device, an absorption device, and combinations thereof. In certain embodiments, the CO₂ removal unit can be configured to remove at least about 50%, at least about 60%, at least about 70%, or even at least about 80% of the CO₂ from the fluid in the anode exhaust conduit 24. In certain further embodiments, the CO₂ removal unit can be configured to remove CO₂ from the fluid in the anode exhaust conduit 24 in a range within any of the values given above, for example, in a range of from 50% to 80%. It is to be understood that the first separation device 30 and the second separation device 32 can be combined or integrated together, and can include other types of separation devices.

In certain embodiments, the fuel cell system as described herein can be configured such that during steady state operation, a ratio of the content of water and carbon dioxide according to the formula [H₂O]+0.5*[CO²] to the content of carbon after mixing the fresh fuel and the anode exhaust 24 and before reforming or pre-reforming can be no greater than 3, no greater than 2, or even no greater than 1.5.

Referring again to FIG. 1, the separation device(s) 30, 32 can then be in fluid communication with an anode recycle pump 34 which can dynamically recycle the fluid in the anode exhaust conduit 24 into the fuel feed conduit 12. The anode recycle pump 34 can be, for example, a blower.

The fuel cell system 10 can further include a temperature measurement device T which is configured to sense a temperature of the fuel cell assembly 16. For example, the temperature measurement device T can be configured to sense the temperature of the fluid in the cathode exhaust conduit 26; in the anode exhaust conduit 24, or inside the fuel cell assembly 16, such as at the cathode 20.

The temperature measurement device T can be coupled to a first controller, which can be coupled to the anode recycle pump 34. The first controller 36 can be configured to control the flow rate of the fluid in the anode exhaust conduit 24 in response to at least a temperature sensed by the temperature measurement device T. For example, the first controller 36 can be configured to send a signal to the anode recycle pump 34 to change the amount of fluid exiting the anode recycle pump 34 in response to the temperature determined by the temperature measurement device T. For example, when the fuel cell temperature is greater than a set point or set range during normal operation, the first controller 36 can send a signal to the anode recycle pump 34 to increase the flow rate of the fluid exiting the anode recycle pump 34. Similarly, when the fuel cell temperature is less than a set point or set range during normal operation, the first controller 36 can send a signal to the anode recycle pump 34 to decrease the flow rate of the fluid exiting the anode recycle pump. Any usable set points or ranges may be used, and may be optimized based on desired performance characteristics of the fuel cell system 10. For example, the set temperature can be the desired operating temperature, or the optimal temperature for the particular fuel cell system arrangement. In certain embodiments, the set range for the temperature can be set in a range of from −5% to +5%, −4% to +4%, or even −3% to +3% of the desired operating temperature. In certain further embodiments, the set point can be any point within the range described above.

In certain further embodiments, the temperature measurement device T is not in communication with the gas feed conduit 18. For example, the temperature measurement device may not be coupled to or in communication with a device which directly influences the flow rate of the fluid in the gas feed conduit 18 entering the fuel cell system 10. Referring to FIG. 1, in certain embodiments, the temperature measurement device T may not be coupled to the second controller 38, which is described in further detail below.

Referring again to FIG. 1, the fuel cell system can further include a bleed conduit 40 in fluid communication with the anode exhaust conduit 24. In certain embodiments, the bleed conduit 40 can be positioned to divert a portion of the fluid in the anode exhaust conduit 24 exiting the anode recycle pump 34 and before entering the fuel feed conduit 12. The bleed conduit 40 can be configured to direct fluid exiting the anode recycle pump 34 to reduce or prevent a build of pressure in the anode exhaust conduit 24 and to remove a build-up of inert gases or other impurities from the fuel cell system 10. For example, inert materials can include nitrogen, argon, or any of the unreacted materials in reactants or products, and the inert materials can accumulate in the fuel cell system. The inert can accumulate in the fuel cell system to at least about 20%, at least about 30%, at least about 40%, or even at least about 50% of the fluid in the anode exhaust conduit depending on how much inert is in the fluid in the fuel feed conduit. The fuel cell system 10 can further include a second controller 38 which can control the flow rate of the fluid which is diverted from the anode exhaust conduit 24. The third controller 38 can be configured to control the flow rate of the fluid diverted from the anode exhaust conduit based on the content of inert fluid in the fuel feed conduit. For example, the flow rate of the fluid diverted from the anode exhaust conduit can be based on the flow rate of the fluid recycled into the fuel feed conduit. For example, in certain embodiments, the flow rate of the fluid bled from the anode exhaust conduit can be no greater than about 2%, 1%, or even 0.5% of the flow rate of the fluid recycled into the fuel feed conduit from the anode exhaust conduit. In further embodiments, the bleed rate can be continuous or periodical. For example, when the bleed rate is periodical, fluid may be bleed from the anode exhaust conduit when a particular level of inert material is present in the anode exhaust conduit. The particular level of inert material may be directly measured, or may be inferred based on the design of the fuel cell system and amount of inert in the fuel feed conduit emanating from the fuel source.

In other embodiments, the second controller 38 can be configured to control flow rate of the fluid diverted from the anode exhaust conduit 24 based on a relationship of energy contents with the fluid in the fuel feed conduit. For example, energy content can be calculated by the formula E=Σxᵢ*LHVᵢ. wherein, E refers to the energy content, xᵢ refers to the mole fraction of the particular fuel. LHVᵢ refers to the lower heating value of the particular fuel based on mole.

In such embodiments, the second controller 38 can be configured to control the flow rate of the fluid diverted from the anode exhaust conduit 24 such that the fluid diverted from the anode exhaust conduit 24 has an energy content of no greater than 5%, no greater than 3%, no greater than 2%, or even no greater than 1% of the energy content in the fluid in the fuel feed conduit.

In certain embodiments, the bleed conduit 40 may also be in fluid communication with the cathode exhaust conduit 26. In certain further embodiments, the bleed conduit 40 may connect to the cathode exhaust conduit 26 prior to the cathode exhaust conduit entering the second heat exchanger 42, which will be described in more detail below. The bleed conduit 40 may alternatively or additionally be in fluid communication with any other desired part of the fuel cell system 10 to take advantage of the heat energy in the fluid in the bleed conduit 40.

The fuel cell system 10 can further include a second heat exchanger 42. The second heat exchanger 42 can be configured to permit heat exchange, for example, from the fluid in the cathode exhaust conduit 26 and a second fluid having a lower temperature than the fluid in the cathode exhaust conduit 26. In a particular embodiments, the second fluid can be the fluid in the gas feed conduit 18. The arrangement of the second heat exchanger 42 can provide additional thermal energy to preheat the fluid in the gas feed conduit 18, thus providing enhanced energy integration within the fuel cell system 10. As described above, the fluid entering the second heat exchanger 42 in the cathode exhaust conduit 26 may contain unreacted fuel that this bleed from the anode exhaust conduit. In certain embodiments, any of the fluid in the bleed conduit, cathode exhaust conduit or the second heat exchanger 42 can contain a catalyst to oxidize unreacted fuel. In certain other embodiments, the inside of the bleed conduit or the inside of cathode exhaust conduit 26, for example, passing through the second heat exchanger 42 can contain a coating which is configured to oxidize unreacted fuel. For example, any oxidation catalyst can be used such as Pt and Pd. Coating materials can include, for example, various ceramics such as porous alumina, cordierite, mullite, zirconia, ceria, and combination thereof.

The fuel cell system 10 can further include a current determining device I. The current determining device I can be configured to determine the current generated by the fuel cell assembly 16. The current measurement device I can be coupled to a controller 46 which can be configured to control the flow rate of the fluid entering the fuel cell system 10 from the fuel source (not shown) in response to the current sensed by the current measurement device I. In other embodiments, the current measurement device I can be coupled to another controller 44 which is configured to control the flow rate of the fluid entering the fuel cell system 10 from the gas source (not shown) or a combination thereof in response to the current sensed by the current measurement device I. For example, in certain embodiments, the controller 46 can be configured to control the desired flow rate based on a set point or set range during normal operation. In certain embodiments, the set range can be in a range of from 0.0222*N*I slpm to 0.178*N*I slpm, 0.0237*N*I slpm to 0.0888*N*I slpm, or even 0.0254*N*I slpm to 0.0444*N*I slpm, wherein the units for the current have the meaning as follows: N is number of cells in series. I is current, ampere. slpm is standard liter per minute at 20° C. Furthermore, in certain embodiments, the set point can be any point within any of the ranges described herein.

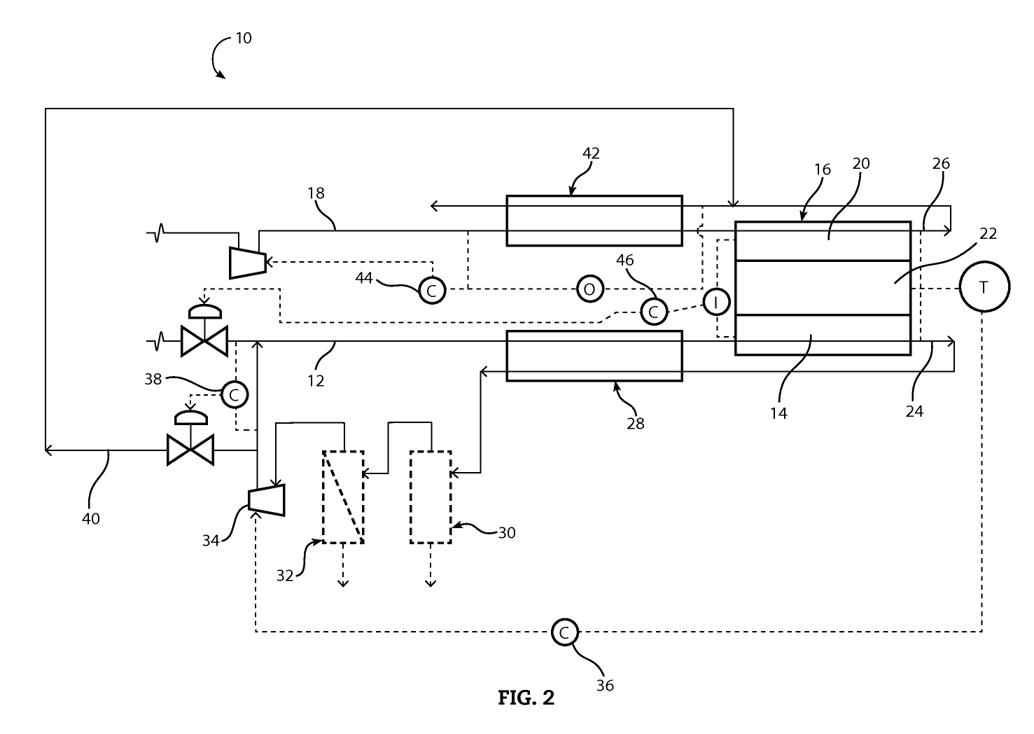

Referring now to FIG. 2, in certain further embodiments, the fuel cell system 10 can further include an oxygen content measurement device O configured to determine the content of oxygen in the fluid in the gas feed conduit and the cathode exhaust conduit. The device to determine the content of oxygen can be coupled to the third controller 44 which can be configured to control the flow rate of the fluid in the gas feed conduit in response to the oxygen utilization of the fuel cell assembly. The oxygen utilization is a measurement of the amount of oxygen used in the fuel cell. The oxygen utilization can be calculated by formula I:

$${O}_{2} utilization = \frac{[ {O}_{2} ] i - [ {O}_{2} ] f}{[ {O}_{2} ] i} \times ( 100 \% ) \qquad ( I )$$

wherein [O₂] i refers to the mole flow rate of oxygen in the gas feed conduit prior to entering the fuel cell assembly; and [O₂] f refers to the mole flow rate of oxygen in the cathode exhaust conduit after exiting the fuel cell assembly. The third controller can be configured to control the flow rate of, for example, the fluid in the gas feed conduit in response to a set point or set range of the oxygen utilization. For example, in certain embodiments, the set range can be from 10 to 80%, 20 to 75%, or even 40 to 70%. The set point can be within any of the ranges disclosed herein.

During steady state operation of a fuel cell system such as described herein, it is possible to obtain an improved performance in, for example, optimum power density; overall fuel utilization, in particular in combination with a low once through fuel utilization, and combinations thereof.

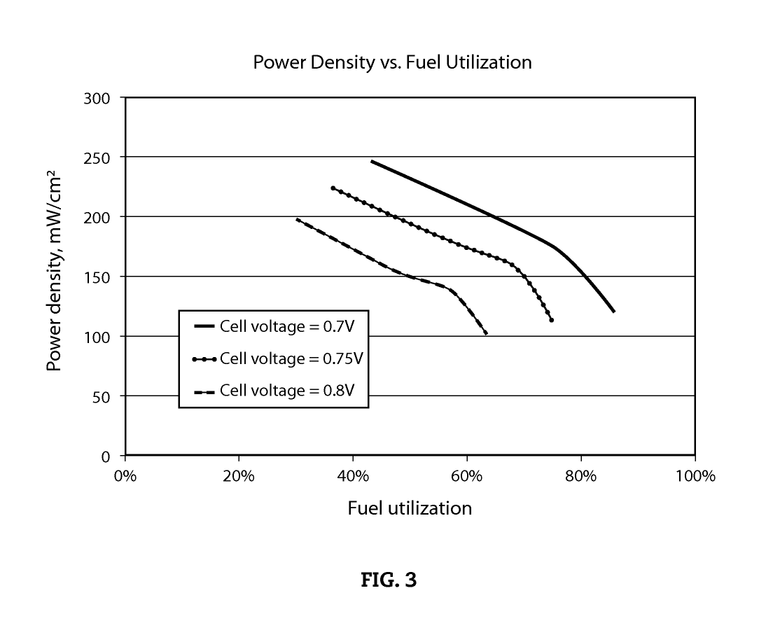

In certain embodiments, the performance of a fuel cell system can be characterized, in part, based on the optimum power density that the fuel cell system can operate. The power density is a measurement from a current/voltage curve such as illustrated in FIG. 3. For example, the power density can be calculated according to formula Power density=I*V/A, wherein I refers to the current in amperes. V refers to the stack voltage; and A refers to the total cell active area.

In certain embodiments, the optimum power density produced by a fuel cell assembly as described herein can be at least 50 mW/cm², at least 75 mW/cm², at least 100 mW/cm² at least 200 mW/cm² at least 250 mW/cm² or even at least 300 mW/cm².

In certain embodiments, the performance of a fuel cell system can be characterized, in part, based on the fuel utilization. The fuel utilization is the percentage of fuel consumed. The overall fuel utilization is the total percentage of fuel consumed in the fuel cell system during steady state. The once through fuel utilization is the percentage of fuel consumed in one pass through the fuel cell system under steady state. In certain embodiments, the overall fuel utilization in a fuel cell system as described herein can be at least 90%, at least 95%, or even at least 98% under steady state. In certain further embodiments, the once through fuel utilization in a fuel cell system as described herein can be no greater than 70%, no greater than 60%, no greater than 50%, no greater than 40%, or even no greater than 30%. In particular embodiments, the overall fuel utilization in a fuel cell system as described herein can be at least 90%, at least 95%, or even at least 98% under steady state and the once through fuel utilization in a fuel cell system as described herein can be no greater than 70%, no greater than 60%, no greater than 50%, no greater than 40%, or even no greater than 30%. A particular achievement of embodiments of the fuel cell system described herein is the ability to obtain a high overall fuel utilization even with a low once through fuel utilization.

Fuel cell systems of the invention can be made by any suitable method known in the art. Any suitable anode and cathode materials known in the art can be used in the invention. Specific examples of the cathode materials include includes a La-manganate based material (e.g., La₁-xMnO₃, where x=0-0.1). In a specific embodiment, the La-manganate based materials are doped with one or more suitable dopants, such as Sr, Ca, Ba or Mg. Examples of doped La-manganate based materials include LaSr-manganates (e.g., La₁-xSrₓMnO₃, where x=0.1-0.3, (La+Sr)/Mn=1.0-0.95 (molar ratio)) and LaCa-manganates (e.g., La₁-xCaₓMnO₃, where x=0.1-0.3, (La+Ca)/Mn=1.0-0.95 (molar ratio)). Specific examples of the anode materials include a Ni cermet. The “Ni cermet” generally refers to a ceramic metal composite that includes Ni, such as about 20 wt %-70 wt % of Ni. Examples of Ni cermets are materials that include Ni and yttria-stabilized zirconia (YSZ), such as ZrO₂ containing about 15 wt % of Y₂O₃, and materials that include Ni and YSr-zirconia.

Any suitable electrolyte material known in the art can be used for electrolyte 18 of the invention. Preferably, electrolyte 18 is a solid electrolyte. Specific examples include ZrO₂ based materials, such as Sc₂O₃-doped ZrO₂, Y₂O₃-doped ZrO₂, and Yb₂O₃-doped ZrO₂; CeO₂ based materials, such as Sm₂O₃-doped CeO₂, Gd₂O₃-doped CeO₂, Y₂O₃-doped CeO₂ and CaO-doped CeO₂; Ln-gallate based materials (Ln=a lanthanide, such as La, Pr, Nd or Sm), such as LaGaO₃ doped with Ca, Sr, Ba, Mg, Co, Ni, Fe or a mixture thereof (e.g., La_{0.8}Sr_{0.2}Ga_{0.8}Mg_{0.2}O₃, La_{0.8}Sr_{0.2}Ga_{0.8}Mg_{0.15}CO_{0.05}O₃, La_{0.9}Sr_{0.1}Ga_{0.8}Mg_{0.2}O₃,

LaSrGaO₄, LaSrGa₃O₇ or La_{0.9}A_{0.1}Ga₃ where A=Sr, Ca or Ba); and mixtures thereof. Other examples include doped yttrium-zirconate (e.g., YZr₂O₇), doped gadolinium-titanate (e.g., Gd₂Ti₂O₇) and brownmillerites (e.g., Ba₂In₂O₆ or Ba₂In₂O₅).

Any suitable thickness of anode 12 and cathode 14 can be employed in the invention. In one specific embodiment, the thickness of anode 14 and cathode 16 is each independently in a range of between about 0.5 mm and about 2 mm.

Any suitable thickness of electrolyte 16 can be employed in the invention. In one specific embodiment, the thickness of electrolyte 16 is in a range of between about 5 microns and about 20 microns, such as between about 5 microns and about 10 microns. In another specific embodiment, the thickness of electrolyte 16 is thicker than about 100 microns.

Another aspect of the present disclosure is directed to a method of operating a fuel cell system. The method can generally include: directing a first fluid into an anode of a fuel cell assembly; directing a second fluid into a cathode of the fuel cell assembly; sensing a temperature in the fuel cell; determining a current of the fuel cell; combining at least a portion of a third fluid exiting the anode of a fuel cell assembly with the first fluid, wherein the flow rate of the third fluid which is combined with the first fluid is directly influenced by the temperature sensed in the fuel cell; and controlling a flow rate of the second fluid in response to the determined current of the fuel cell.

In yet another aspect of the present disclosure, a method of operating a fuel cell system can include: directing a first fluid into an anode of a fuel cell assembly; directing a second fluid into a cathode of the fuel cell assembly; sensing a temperature in the fuel cell; determining an oxygen utilization of the fuel cell assembly; combining at least a portion of a third fluid exiting the anode of a fuel cell assembly with the first fluid, wherein the flow rate of the third fluid which is combined with the first fluid is directly influenced by the temperature sensed in the fuel cell; and controlling a flow rate of the second fluid in response to the determined oxygen utilization of the fuel cell assembly.

In certain further embodiments, the method can include directing a portion of the third fluid to be combined with a fourth fluid exiting the cathode of the fuel cell assembly. The flow rate of the portion of the third fluid which is combined with the fourth fluid to reduce the build up of inert gasses within the fuel cell system.

It is to be understood that the method described herein can further include any portion or perform the associated function of any component in fuel cell systems described herein. Moreover, the methods described herein allow for the significant improvement in the performance of the fuel cell assembly and system, such as for example, by increasing power density, having a reduced temperature gradient in the fuel cell assembly, due to the heat exchangers, reducing parasitic power consumption, improving the fuel system efficiency, having better power transient performance, and improved fuel utilization.

Items

Item 1: A fuel cell system comprising: a fuel cell assembly comprising an anode and a cathode; a fuel feed conduit in fluid communication with the fuel cell assembly; a gas feed conduit in fluid communication with the fuel cell assembly, an anode exhaust conduit in fluid communication with the fuel cell assembly, wherein the anode exhaust conduit is in fluid communication with the fuel feed conduit and wherein at least a portion of a fluid in the anode exhaust conduit is recycled to the fuel feed conduit; a temperature measurement device for determining a fuel cell temperature; a current measurement device for determining a fuel cell current; a first control in communication with the temperature measurement device, wherein the first control is configured to control a flow rate of the fluid in the anode exhaust conduit which is recycled into the fuel feed conduit in response to the fuel cell temperature; and a second control in communication with the current measurement device, wherein the second control is configured to control a flow rate of a fluid in the gas feed conduit in response to the fuel cell current.

Item 2: The fuel cell system according to item 1, wherein the second control is configured to control a flow rate of the fluid in the gas feed conduit in response to a set point or set range of the fuel cell current.

Item 3: The fuel cell system according to item 2, wherein the set range is from 0.0222*N *I slpm to 0.178*N*I slpm, 0.0237*N*I slpm to 0.0888*N*I slpm, or 0.0254*N*I slpm to 0.0444*N*I slpm, wherein N refers to the number of cells in series, I refers to the current, Ampere, and slpm refers to standard liter per minute at 20° C.

Item 4: A fuel cell system comprising: a fuel cell assembly comprising an anode and a cathode; a fuel feed conduit in fluid communication with the fuel cell assembly; a gas feed conduit in fluid communication with the fuel cell assembly, an anode exhaust conduit in fluid communication with the fuel cell assembly; wherein the anode exhaust conduit is in fluid communication with the fuel feed conduit and wherein at least a portion of a fluid in the anode exhaust conduit is recycled to the fuel feed conduit; a cathode exhaust conduit in fluid communication with the fuel cell assembly; a temperature measurement device for determining a fuel cell temperature; an oxygen content measurement device for determining an oxygen content of fluid in the cathode exhaust conduit; a first control in communication with the temperature measurement device, wherein the first control is configured to control a flow rate of the fluid in the anode exhaust conduit which is recycled into the fuel feed conduit in response to the fuel cell temperature; and a second control in communication with the oxygen content measurement device, wherein the second control is configured to control a flow rate of a fluid in the gas feed conduit in response to the oxygen content of the fluid in the cathode exhaust conduit.

Item 5: The fuel cell system according to item 4, wherein the second control is configured to control a flow rate of the fluid in the gas feed conduit in response to an oxygen utilization of the fuel cell.

Item 6: The fuel cell system according to item 5, wherein the second control is configured to control a flow rate of the fluid in the gas feed conduit in response to a set point of the oxygen utilization of the fuel cell system.

Item 7: The fuel cell system according to item 5, wherein the second control is configured to control a flow rate of the fluid in the gas feed conduit in response to a set range of the oxygen utilization of the fuel cell.

Item 8: The fuel cell system according to item 7, wherein the set range of the oxygen utilization of the fuel cell is from 10% to 80%, 20% to 75%, or 40% to 70%.

Item 9: The fuel cell system according to any one of the preceding items, wherein the temperature measurement device is not in communication with the gas feed conduit.

Item 10: The fuel cell system according to any one of the preceding items, wherein the flow rate of the fluid in the gas feed conduit or a flow rate of the fluid entering the fuel cell system in the fuel feed conduit is not changed in direct response to the temperature of the fuel cell.

Item 11: The fuel cell system according to any one of the preceding items, wherein the flow rate of the fluid in the anode exhaust conduit is the only fluid flow rate directly influenced by the temperature in the fuel cell assembly.

Item 12: The fuel cell system according to any one of the preceding items further comprising a third control configured to control a flow rate of the fluid entering the fuel cell system in the fuel feed conduit in response to the fuel cell current.

Item 13: The fuel cell system according to any one of the preceding items, further comprising a first heat exchanger, wherein the first heat exchanger is configured to exchange heat energy from the fluid in the anode exhaust conduit or the cathode exhaust conduit to the fluid in the fuel feed conduit or gas feed conduit.

Item 14: The fuel cell system according item 13, wherein the first heat exchanger is configured to exchange heat energy from the fluid in the anode exhaust conduit to the fluid in the fuel feed conduit.

Item 15: The fuel cell system according to any one of the preceding items, further comprising a second heat exchanger, wherein the second heat exchanger is configured to exchange heat energy from the fluid in the anode exhaust conduit or the cathode exhaust conduit to the fluid in the fuel feed conduit or gas feed conduit.

Item 16: The fuel cell system according to item 15, wherein the first heat exchanger is configured to exchange heat energy from the fluid in the cathode exhaust conduit to the fluid in the gas feed conduit.

Item 17: The fuel cell system according to item 15, wherein the first heat exchanger comprises a pre-reformer or a reformer.

Item 18: The fuel cell system according to any one of the preceding items, wherein more than 50% of the fluid in the fuel feed conduit is reformed in the anode side of the fuel cell.

Item 19: The fuel cell system according to any one of the preceding items, wherein the anode exhaust conduit is in fluid communication with a first separation device, and wherein the first separation device is configured to separate water from the anode exhaust conduit.

Item 20: The fuel cell system according to item 19, wherein the first separation device is selected from the group consisting of a membrane separation device, a condenser, an adsorption device, an absorption device, and combinations thereof.

Item 21: The fuel cell system according to item 20, wherein the first separation device comprises a condenser.

Item 22: The fuel cell system according to any one of the preceding items, wherein the anode exhaust conduit is in fluid communication with a second separation device, and wherein the second separation device is configured to separate CO₂ from the fluid in the anode exhaust conduit.

Item 23: The fuel cell system according to item 22, wherein the second separation device is selected from the group consisting of a membrane separation device, a chemical absorption device, an adsorption device, and combinations thereof.

Item 24: The fuel cell system according to any one of the preceding items, wherein the anode exhaust conduit is in fluid communication with a bleed conduit.

Item 25: The fuel cell system according to item 24, wherein the bleed conduit is in fluid communication with the cathode exhaust conduit.

Item 26: The fuel cell system according to item 25, wherein the bleed conduit is configured to exchange heat energy from the fluid exiting the bleed conduit to the gas feed conduit.

Item 27: The fuel cell system according to any one of the preceding items, wherein the fuel cell assembly comprises a solid oxide fuel cell.

Item 28: The fuel cell system according to any one of the preceding items, wherein the anode exhaust conduit is in fluid communication with the cathode exhaust conduit.

Item 29: The fuel cell system according to item 28, further comprising a third control, wherein the third control is configured to control a flow rate of the fluid in the anode exhaust conduit which is fed to the cathode exhaust conduit.

Item 30: The fuel cell system according to item 29, wherein the third control is configured to control the flow rate of the fluid in the anode exhaust conduit which is fed to the cathode exhaust conduit in response to the flow rate of the fluid entering the fuel cell system in the fuel feed conduit.

Item 31: The fuel cell system according to item 29, wherein the flow rate of the fluid in the anode exhaust conduit which is fed to the cathode exhaust conduit is no greater than 7%, no greater than 5%, or no greater than 1% than the flow rate of the fluid entering the fuel cell system in the fuel feed conduit.

Item 32: The fuel cell system according to any one of the preceding items, wherein the fuel cell temperature is: the temperature of the fluid in the cathode exhaust conduit, the temperature of the fluid in the anode exhaust conduit, or the temperature at the cathode inside the fuel cell.

Item 33: The fuel cell system according to any one of the preceding items, wherein the fluid in the fuel conduit comprises natural gas, LPG, biogas, biofuel, syngas, coal gas, city gas, methane, propane, gasoline, diesel, H₂, or combinations thereof.

Item 34: The fuel cell system according to any one of the preceding items, wherein the fluid in the gas feed conduit comprises oxygen.

Item 35: The fuel cell system according to any one of the preceding items, wherein under steady state, the fuel cell assembly exhibits a maximum power density of at least 50 mW/cm², at least 75 mW/cm², at least 100 mW/cm² at least 200 mW/cm² at least 250 mW/cm² or at least 300 mW/cm².

Item 36: The fuel cell system according to any one of the preceding items, wherein under steady state, the fuel cell system exhibits an overall fuel utilization of at least 90%, at least 95%, or at least 98%.

Item 37: The fuel cell system according to any one of the preceding items, wherein, under steady state, the fuel cell system exhibits an overall fuel utilization of at least 90%, at least 95%, at least 96%, at least 97% or even at least 98%.

Item 38: The fuel cell system according to any one of the preceding items, wherein, under steady state, the fuel cell assembly exhibits a once through fuel utilization of no greater than 70%, no greater than 60%, no greater than 50%, no greater than 40%, or even no greater than 30%.

Item 39: The fuel cell system according to any one of the preceding items, wherein, under steady state, the fuel cell system exhibits ratio of ([H₂O]+0.5*[CO₂]) in the fluid recycled into the fuel feed conduit from the anode exhaust conduit to the content of carbon in the fluid in the fuel feed conduit is less than 3, less than 2, or even less than 1.5.

Item 40: A method of operating a fuel cell system comprising directing a first fluid into an anode of a fuel cell assembly; directing a second fluid into a cathode of the fuel cell assembly; sensing a temperature in the fuel cell; determining a current of the fuel cell; combining at least a portion of a third fluid exiting the anode of a fuel cell assembly with the first fluid, wherein the flow rate of the third fluid which is combined with the first fluid is directly influenced by the temperature sensed in the fuel cell; and controlling a flow rate of the second fluid in response to the determined current of the fuel cell.

Item 41: A method of operating a fuel cell system comprising directing a first fluid into an anode of a fuel cell assembly; directing a second fluid into a cathode of the fuel cell assembly; sensing a temperature in the fuel cell; determining an oxygen utilization of the fuel cell assembly; combining at least a portion of a third fluid exiting the anode of a fuel cell assembly with the first fluid, wherein the flow rate of the third fluid which is combined with the first fluid is directly influenced by the temperature sensed in the fuel cell; and controlling a flow rate of the second fluid in response to the determined oxygen utilization of the fuel cell assembly.

### EXAMPLES

In a first example, an SOFC system as illustrated in FIG. 1 is arranged. The operating conditions were set as follows: the set temperature of the stack was set to 825° C. and was controlled within a range of +1-3%; the once through fuel utilization was set to a range of between 30% to 85%; and the oxygen utilization was set to a range of 10% to 30%. Control of the recycle rate is based on stack temperature, and control of fresh fuel and air is based on cell current. The SOFC system was operated at steady state and evaluated to determine the maximum power density and overall fuel utilization achieved at three different cell voltages, 0.7V, 0.75V, and 0.8V. FIG. 3 illustrates a plot of the results.

Many different aspects and embodiments are possible. Some of those aspects and embodiments are described herein. After reading this specification, skilled artisans will appreciate that those aspects and embodiments are only illustrative and do not limit the scope of the present invention. Certain features that are, for clarity, described herein in the context of separate embodiments, may also be provided in combination in a single embodiment. Conversely, various features that are, for brevity, described in the context of a single embodiment, may also be provided separately or in any subcombination. Further, reference to values stated in ranges includes each and every value within that range.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

What is claimed is:

1. A fuel cell system comprising:
a fuel cell assembly comprising an anode and a cathode;
a fuel feed conduit in fluid communication with the fuel cell assembly;
a gas feed conduit in fluid communication with the fuel cell assembly,
an anode exhaust conduit in fluid communication with the fuel cell assembly, wherein the anode exhaust conduit is in fluid communication with the fuel feed conduit and wherein at least a portion of a fluid in the anode exhaust conduit is recycled to the fuel feed conduit;
a temperature measurement device for determining a fuel cell temperature;
a current measurement device for determining a fuel cell current;
a first control in communication with the temperature measurement device, wherein the first control is configured to control a flow rate of the fluid in the anode exhaust conduit which is recycled into the fuel feed conduit in response to the fuel cell temperature; and
a second control in communication with the current measurement device, wherein the second control is configured to control a flow rate of a fluid in the gas feed conduit in response to the fuel cell current.

2. The fuel cell system according to claim 1, wherein the second control is configured to control a flow rate of the fluid in the gas feed conduit in response to a set point or set range of the fuel cell current.

3. The fuel cell system according to claim 2, wherein the set range is from 0.0222*N*I slpm to 0.178*N*I slpm, wherein N refers to the number of cells in series, I refers to the current in amperes, and slpm refers to standard liter per minute at 20° C.

4. The fuel cell system according to claim 1, wherein, under steady state, the fuel cell assembly exhibits a once through fuel utilization of no greater than

5. The fuel cell system according to claim 1, further comprising a third control configured to control a flow rate of the fluid entering the fuel cell system in the fuel feed conduit in response to the fuel cell current.

6. The fuel cell system according to claim 1, wherein more than 50% of the fluid in the fuel feed conduit is reformed in the anode side of the fuel cell.

7. The fuel cell system according to claim 1, wherein the anode exhaust conduit is in fluid communication with a first separation device, and wherein the first separation device is configured to separate water from the anode exhaust conduit.

8. The fuel cell system according to claim 1, wherein the anode exhaust conduit is in fluid communication with a second separation device, and wherein the second separation device is configured to separate CO₂ from the fluid in the anode exhaust conduit.

9. The fuel cell system according to claim 1, wherein the anode exhaust conduit is in fluid communication with a bleed conduit.

10. The fuel cell system according to claim 9, wherein the bleed conduit is in fluid communication with the cathode exhaust conduit.

11. The fuel cell system according to claim 1, wherein the anode exhaust conduit is in fluid communication with the cathode exhaust conduit.

12. The fuel cell system according to claim 11, further comprising a third control, wherein the third control is configured to control a flow rate of the fluid in the anode exhaust conduit which is fed to the cathode exhaust conduit.

13. The fuel cell system according to claim 12, wherein the flow rate of the fluid in the anode exhaust conduit which is fed to the cathode exhaust conduit is no greater than 7% of the flow rate of the fluid entering the fuel cell system in the fuel feed conduit.

14. A fuel cell system comprising:
a fuel cell assembly comprising an anode and a cathode;
a fuel feed conduit in fluid communication with the fuel cell assembly;
a gas feed conduit in fluid communication with the fuel cell assembly,
an anode exhaust conduit in fluid communication with the fuel cell assembly; wherein the anode exhaust conduit is in fluid communication with the fuel feed conduit and wherein at least a portion of a fluid in the anode exhaust conduit is recycled to the fuel feed conduit;
a cathode exhaust conduit in fluid communication with the fuel cell assembly;
a temperature measurement device for determining a fuel cell temperature;
an oxygen content measurement device for determining an oxygen content of fluid in the cathode exhaust conduit;
a first control in communication with the temperature measurement device, wherein the first control is configured to control a flow rate of the fluid in the anode exhaust conduit which is recycled into the fuel feed conduit in response to the fuel cell temperature; and
a second control in communication with the oxygen content measurement device, wherein the second control is configured to control a flow rate of a fluid in the gas feed conduit in response to the oxygen content of the fluid in the cathode exhaust conduit.

15. The fuel cell system according to claim 14, wherein the second control is configured to control a flow rate of the fluid in the gas feed conduit in response to an oxygen utilization of the fuel cell.

16. The fuel cell system according to claim 15, wherein the second control is configured to control a flow rate of the fluid in the gas feed conduit in response to a set point of the oxygen utilization of the fuel cell system.

17. The fuel cell system according to claim 15, wherein the second control is configured to control a flow rate of the fluid in the gas feed conduit in response to a set range of the oxygen utilization of the fuel cell.

18. The fuel cell system according to claim 14, wherein, under steady state, the fuel cell assembly exhibits a once through fuel utilization of no greater than 70%.

19. The fuel cell system according to claim 14, wherein the anode exhaust conduit is in fluid communication with the cathode exhaust conduit.

20. A method of operating a fuel cell system comprising
directing a first fluid into an anode of a fuel cell;
directing a second fluid into a cathode of the fuel cell;
sensing a temperature in the fuel cell;
determining a current of the fuel cell or an oxygen utilization of the fuel cell;
combining at least a portion of a third fluid exiting the anode of a fuel cell assembly with the first fluid, wherein the flow rate of the third fluid which is combined with the first fluid is directly influenced by the temperature sensed in the fuel cell; and
controlling a flow rate of the second fluid in response to the determined current of the fuel cell or the determined oxygen utilization of the fuel cell.
